(19) United States
(12) Patent Application Publication
(10) Pub. No.: US 2009/0129313 A1
(43) Pub. Date: May 21, 2009

(54) CONTROL STATION DEVICE, BASE STATION DEVICE, AND PACKET DATA DISCARDING METHOD

(75) Inventors: Tomofumi Tamura, Kanagawa (JP); Akito Fukui, Kanagawa (JP); Kenichiro Iida, Kanagawa (JP)

Correspondence Address: Dickinson Wright PLLC;James E. Ledbetter, Esq., International Square, 1875 Eye Street, N.W., Suite 1200, Washington, DC, 20006, US

(73) Assignee: MATSUSHITA ELECTRIC INDUSTRIAL CO., LTD., OSAKA (JP)

(21) Appl. No.: 11/577,946

(22) PCT Filed: Oct. 19, 2005
(86) PCT No.: PCT/JP05/19206

§ 371 Date: Apr. 25, 2007

(30) Foreign Application Priority Data
Oct. 27, 2004 (JP) 2004-312077

(51) Int. Cl. H04W 8/00

(52) U.S. Cl. 370/328

(57) ABSTRACT

There is provided a control station device capable of suppressing a traffic amount by discarding packet data to be discarded by a control station device, without transmitting the packet data from the base station device to the control station device. In this device, a buffer (102) stores upstream packet data and discards it without outputting it when a predetermined time has elapsed after the storing of the upstream packet data. According to maximum wait time information, a timer management unit (106) makes an instruction to discard the upstream packet data which is to be discarded even if transmitted to an RNC, without transmitting it to the RNC (122). An alignment buffer (112) corrects the upstream packet data order inversion and discards the upstream packet data for which the maximum wait time has elapsed. A timer management unit (113) sets the maximum wait time and instructs the alignment buffer (112) to discard the upstream packet data for which the maximum wait time has elapsed.

### TECHNICAL FIELD

The present invention relates to a control station apparatus, a base station apparatus and a packet data discarding method. More particularly, the present invention relates to, for example, a control station apparatus, a base station apparatus and a packet data discarding method applied to a W-CDMA high-speed packet transmission scheme.

### BACKGROUND ART

HSUPA (High Speed Uplink Packet Access) has been standardized as the W-CDMA high-speed packet transmission scheme. According to HSUPA, a high-speed uplink channel from a mobile terminal to a radio base station apparatus is realized by applying methods such as HARQ (Hybrid Automatic Repeat reQuest) and scheduling of the transmission destination user by a radio base station apparatus, to a wireless channel. Also, in order to stabilize and ensure uninterruptible communication between radio base station apparatuses, or between sectors upon hand-over, and, at the same time, maximize system capacity, a mobile terminal transmits the same packet data to a plurality of radio base station apparatuses, and soft hand-over is carried out to select and combine data by means of a wireless network control apparatus.

Conventionally, upon applying HSUPA, HARQ on a wireless interval (Uu) interface, the flow control on a wired interval (Iub/Iur) interface, and the order reversal of packet data which occurs by executing soft hand-over, are corrected in a buffer arranged in an RNC.

A mobile communication system is comprised of a mobile terminal (hereinafter “UE”), a radio base station apparatus (hereinafter “Node B”), a wireless network control apparatus that controls Node B (hereinafter “RNC”), and a core network (hereinafter “CN”) that carries out position management, call control, and the like of the UE (for example, Non-patent Document 1). FIG. 1 shows one example of a mobile communication system, wherein RNC 12 and RNC 13 are connected via CN 11. Also, RNC 12 is connected to Node B 14, Node B 15 and Node B 16, and RNC 13 is connected to Node B 17 and Node B 18. Also, UE 19 is connected by a wireless channel under Node B 14, Node B 15 and Node B 16. UE 19 transmits the same packet data to Node B 14, Node B 15 and Node B 16, to carry out soft hand-over.

Also, FIG. 2 shows one example of a protocol architecture of a user plane upon applying HSUPA (for instance, Non-patent Document 2). In MAC-e (Medium Access Control for Enhanced Dedicated Channel) layer on the Uu interface between Node B and UE, HARQ and scheduling by Node B are carried out. Also, in the EDCH FP layer between Node B and RNC, flow control is carried out with respect to uplink data frames.

### Non-patent Document 1: 3GPP, TS25.401 UTRAN Overall Description, V6.3.0

### Non-patent Document 2: 3GPP, TS25.309 FDD Enhanced Uplink Overall Description Stage 2 V1.0.0

### DISCLOSURE OF INVENTION

### Problems to be Solved by the Invention

However, in the conventional apparatuses, a predetermined time passes, due to the flow control between RNC and Node B, there are cases where the packet data decided to be discarded by the buffer of the RNC, is held in the buffer of Node B. At this time, since there is no compatibility between the buffer of RNC and the buffer of Node B, there is a problem that Node B transmits the packet data decided to be discarded in the RNC, to the RNC, and increases the amount of traffic.

It is therefore an object of the present invention to provide a control station apparatus, a base station apparatus and a packet data discarding method which suppress the amount of traffic by discarding packet data that is to be discarded in the control station apparatus, in the base station apparatus, instead of transmitting that packet data from the base station apparatus to the control station apparatus.

### Means for Solving the Problem

In accordance with one aspect of the present invention, the control station apparatus of the present invention adopts a configuration having: a receiving section that receives packet data transmitted from a base station apparatus; a first accumulating section that accumulates the packet data received by the receiving section on a temporary basis and arranges the accumulated packet data in a right order; a protocol processing section that carries out predetermined protocol processing on the packet data arranged in the right order at the first accumulating section; a timer managing section that sets a maximum waiting time, which is a predetermined time from when the packet data is accumulated in the first accumulating section until the packet data is discarded without being subjected to the protocol processing at the protocol processing section; and a reporting section that reports information about the maximum waiting time set by the timer managing section, to the base station apparatus.

According to another aspect of the present invention, the packet data discarding method of the present invention includes: transmitting packet data from a communication terminal apparatus to a base station apparatus; accumulating the packet data received by the base station apparatus, in the base station apparatus, on a temporary basis; transmitting the packet data accumulated in the base station apparatus to a control station apparatus at a predetermined timing; accumulating the packet data received by the control station apparatus in the control station apparatus on a temporary basis and arranging the accumulated packet data in a right order; carrying out predetermined protocol processing on the packet data arranged in the right order; setting a maximum waiting time, which is a predetermined time from when the packet data is accumulated until the packet data is discarded without being subjected to the protocol processing; transmitting information about the set maximum waiting time from the control station apparatus to the base station apparatus; receiving at the base station apparatus information about the maximum waiting time from the control station apparatus; and at the base station apparatus, discarding, from the packet data accumulated in the base station apparatus, packet data that is going to be discarded if transmitted to the control station apparatus, instead of transmitting the packet data to the control station apparatus, based on the information about the maximum waiting time received at the base station apparatus.

### ADVANTAGEOUS EFFECT OF THE INVENTION

According to the present invention, the amount of traffic can be suppressed by discarding packet data that is to be discarded in the control station apparatus, in the base station apparatus, instead of transmitting that packet data from the base station apparatus to the control station apparatus.

### BRIEF DESCRIPTION OF DRAWINGS

FIG. 1 shows a frame format of a configuration of a mobile communication system;

FIG. 2 shows a protocol architecture of a user plane upon applying HSUPA;

FIG. 3 is a block diagram showing a configuration of a communication system according to an embodiment of the present invention;

FIG. 4 is a sequence diagram showing an operation of a base station apparatus and a control station apparatus according to an embodiment of the present invention;

FIG. 5 is a sequence diagram showing an operation of the control station apparatus according to an embodiment of the present invention;

FIG. 6A shows a state of an alignment buffer according to an embodiment of the present invention;

FIG. 6B shows a state of the alignment buffer according to an embodiment of the present invention;

FIG. 6C shows a state of the alignment buffer according to an embodiment of the present invention;

FIG. 6D shows a state of the alignment buffer according to an embodiment of the present invention;

FIG. 6E shows a state of the alignment buffer according to an embodiment of the present invention; and

FIG. 6F shows a state of the alignment buffer according to an embodiment of the present invention.

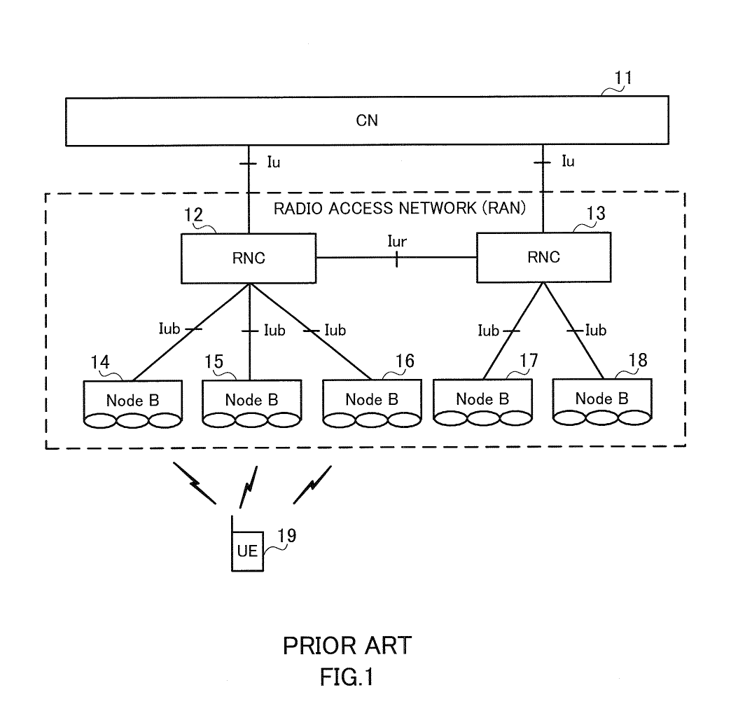

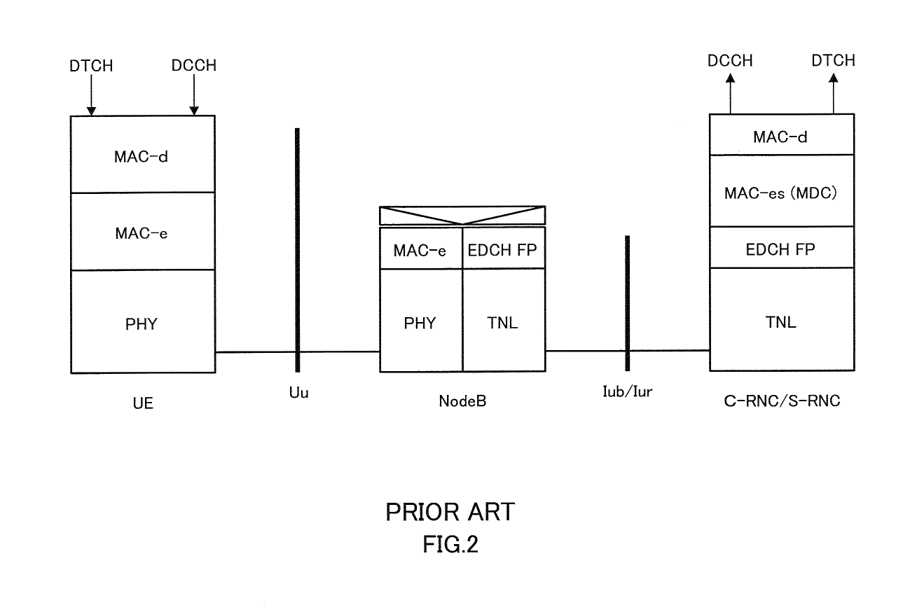

### BEST MODE FOR CARRYING OUT THE INVENTION

Now, embodiments of the present invention will be described in detail with reference to the accompanying drawings.

### Embodiment

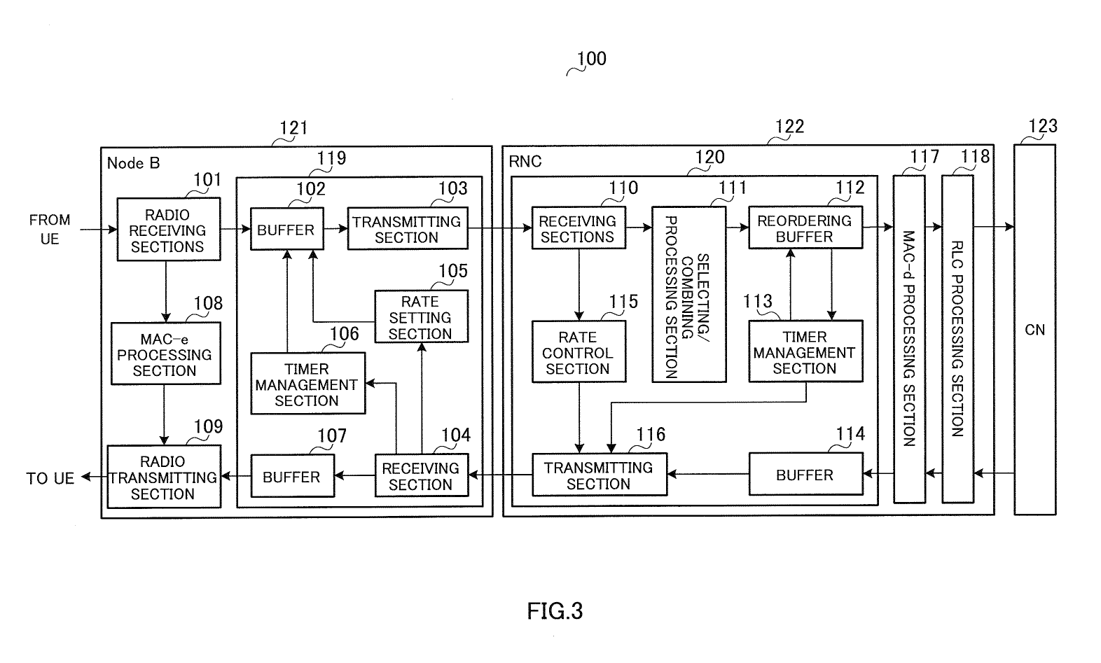

FIG. 3 is a block diagram showing a configuration of communication system 100 according to an embodiment of the present invention. Communication system 100 is comprised of Node B 121, RNC 122 and CN 123. In FIG. 3, UE, the other RNC's and the other Nodes B are omitted, for ease of explanation.

First, the configuration of Node B 121 will be described. Buffer 102, transmitting section 103, receiving section 104, rate setting section 105, timer managing section 106 and buffer 107 constitute FP processing section 119.

Radio receiving section 101 receives packet data which is uplink user data transmitted from a UE (not shown) by radio, carries out radio processing to convert radio frames of the received uplink packet data into user frames and outputs the result to buffer 102 and MAC-e processing section 108.

Buffer 102 is a second accumulating means and stores the uplink packet data inputted from radio receiving section 101 on a temporary basis. Then, buffer 102 outputs the uplink packet data stored therein, to transmitting section 103, at a transmission rate and transmission timing set in rate setting section 105. Also, when a predetermined time has passed from the time the uplink packet data was stored, upon command from timer managing section 106, buffer 102 discards the uplink packet data stored therein, instead of to outputting the packet data to transmitting section 103.

Transmitting section 103 carries out FP processing on the uplink packet data inputted from buffer 102 to convert the user frames into FP frames, and transmits the result to receiving section 110 of RNC 122 by wired communication.

Receiving section 104 carries out FP processing on the downlink packet data which it received from transmitting section 116 of RNC 122, and outputs the result to buffer 107. Also, receiving section 104 outputs information about the transmission rate which it received from transmitting section 116, to rate setting section 105. Also, receiving section 104 outputs information about the maximum waiting time (reordering release timer), which it received from transmitting section 116 to timer managing section 106.

Rate setting section 105 sets a predetermined transmission rate and transmission timing based on information about the transmission rate inputted from receiving section 104, and commands buffer 102 to output uplink packet data at the set transmission rate and transmission timing.

Based on information about the maximum waiting time inputted from receiving section 104, timer managing section 106, which is a discarding means, sends command so that uplink data which will be discarded even when it is transmitted to RNC 122, is discarded, instead of being transmitted to RNC 122. To be more specific, timer managing section 106 has a frame discarding timer synchronized with a frame discarding timer of timer managing section 113 of RNC 122 (described later), and, when the time specified by the information about the maximum waiting time has passed, timer managing section 106 commands buffer 102 to discard the uplink packet data. Next, the method for discarding packet data will be later described.

Buffer 107 stores downlink packet data inputted from receiving section 104 on a temporary basis, and outputs the stored downlink packet data to radio transmitting section 109 at a predetermined timing. MAC-e processing section 108 carries out MAC-e processing such as HARQ and scheduling, with respect to the uplink packet data inputted from radio receiving section 101. To be more specific, MAC-e processing section 108 demodulates uplink packet data inputted from radio receiving section 101, and, at the same time, carries out HARQ decoding and error correction. In addition, when the uplink packet data inputted from radio receiving section 101 was received at a desired timing, MAC-e processing section 108 generates an ACK signal showing that reception was successful, and outputs the ACK signal to radio transmitting section 109. When the uplink packet data inputted from radio receiving section 101 was not received at a desired timing, MAC-e processing section generates a NACK signal showing that reception failed, and outputs the NACK signal to radio transmitting section 109. Also, from the uplink packet data inputted from radio receiving section 101, MAC-e processing section 108 generates channel quality information, which represents information that shows the channel quality of the wireless channel for each UE. Then, based on the channel quality information of the wireless channel between the plurality of UEs that has been generated, MAC-e processing section 108 determines, for example, the transmission timing for each UE and the modulation scheme to be used upon transmission, and outputs the information about the transmission timing, the information about the modulation scheme, and the like information, which have been determined, to radio transmitting section 109.

Radio transmitting section 109 carries out radio processing on the downlink packet data inputted from buffer 107 and transmits the result to a UE (not shown) by radio. Also, radio transmitting section 109 carries out radio processing on the transmission timing information and modulation scheme information, and the like information, and on the ACK signal or the NACK signal which have been inputted from MAC-e processing section 108, and transmits them to the above-described UE by radio.

Next, the configuration of RNC 122 will be described. Receiving section 110, selecting and combining section 111, alignment buffer 112, timer managing section 113, buffer 114, rate control section 115 and transmitting section 116 constitute FP processing section 120.

Receiving section 110 carries out FP processing on the uplink packet data transmitted from transmitting section 103 to convert FP frames into user frames, and outputs the result to selecting and combining processing section 111 and rate control section 115.

Selecting and combining processing section 111 selects and combines the uplink packet data of a plurality of Nodes B inputted from receiving section 110, and outputs the result to alignment buffer 112.

Alignment buffer 112 is a first accumulating means, and corrects the order reversal of the uplink packet data caused by the number of retransmissions which varies by HARQ, the transmission delay due to the flow control on the Iub/Iur interface, and the differing transmission delays between a plurality of Nodes B's upon applying soft handover, stores the uplink packet data inputted from selecting and combining processing section 111 on a temporary basis, and, at the same time, reorders the uplink packet data stored therein back in the right order, and outputs the result to MAC-d processing section 117. Also, upon command from timer managing section 113, when a predetermined time has passed from the time the uplink packet data was stored, alignment buffer 112 discards the uplink packet data stored therein, instead of outputting that packet data to MAC-d processing section 117.

Timer managing section 113 has a frame discarding timer synchronized with the frame discarding timer of timer managing section 106 of Node B. Timer managing section 113 sets the maximum waiting time, which is the time allowed from when the uplink packet data stored in alignment buffer 112 is stored until it is outputted to MAC-d processing section 117, in the frame discarding timer, and commands alignment buffer 112 to discard uplink packet data which has passed the maximum waiting time. Also, timer managing section 113 outputs the information about maximum waiting time to transmitting section 116.

Buffer 114 stores downlink packet data inputted from MAC-d processing section 117 on a temporary basis, and outputs the downlink packet data stored therein, to transmitting section 116 at a predetermined timing.

Rate control section 115 monitors the traffic state and the like on the wired channel between RNC 122 and Node B 121, based on the uplink packet data inputted from receiving section 110, and sets the transmission rate of the uplink packet data to be transmitted from Node B 121 to RNC 122. Then, rate control section 115 outputs information about the set transmission rate to transmitting section 116.

Transmitting section 116 carries out FP processing on downlink packet data inputted from buffer 114 to generate FP frames, and transmits them to receiving section 104 of Node B 121 by wired communication. Also, transmitting section 116 transmits the information about the transmission rate inputted from rate control section 115, to receiving section 104 of Node B 121 by wired communication. Also, transmitting section 116 transmits information about the maximum waiting time inputted from timer managing section 113, to receiving section 104 of Node B 121 by wired communication.

MAC-d processing section 117 carries out MAC-d layer processing on the uplink packet data inputted from alignment buffer 112 and outputs the result to RLC processing section 118. Also, MAC-d processing section 117 carries out MAC-d layer processing on the downlink packet data inputted from RLC processing section 118 and outputs the result to buffer 114.

RLC processing section 118 carries out RLC processing including retransmission control, and carries out RLC processing on the uplink packet data inputted from MAC-d processing section 117 and transmits the result to CN 123 by wired communication, and, at the same time, carries out RLC processing on the downlink packet data received from CN 123 by wired communication, and outputs the result to MAC-d processing section 117. RLC processing and MAC-d processing are described in detail in 3GPP, TS25.322 Radio Link Control (RLC) Protocol Specification, V6.1.0 and 3GPP, TS25.321 Medium Access Control (MAC) Protocol Specification, V3.14.0.

CN 123 transmits the uplink packet data received from RLC processing section 118 of RNC 122 to another RLC (not shown), and, at the same time, transmits the downlink packet data transferred from that RNC to RLC processing section 118. Also, CN 123 carries out position management and call control and the like of the UE.

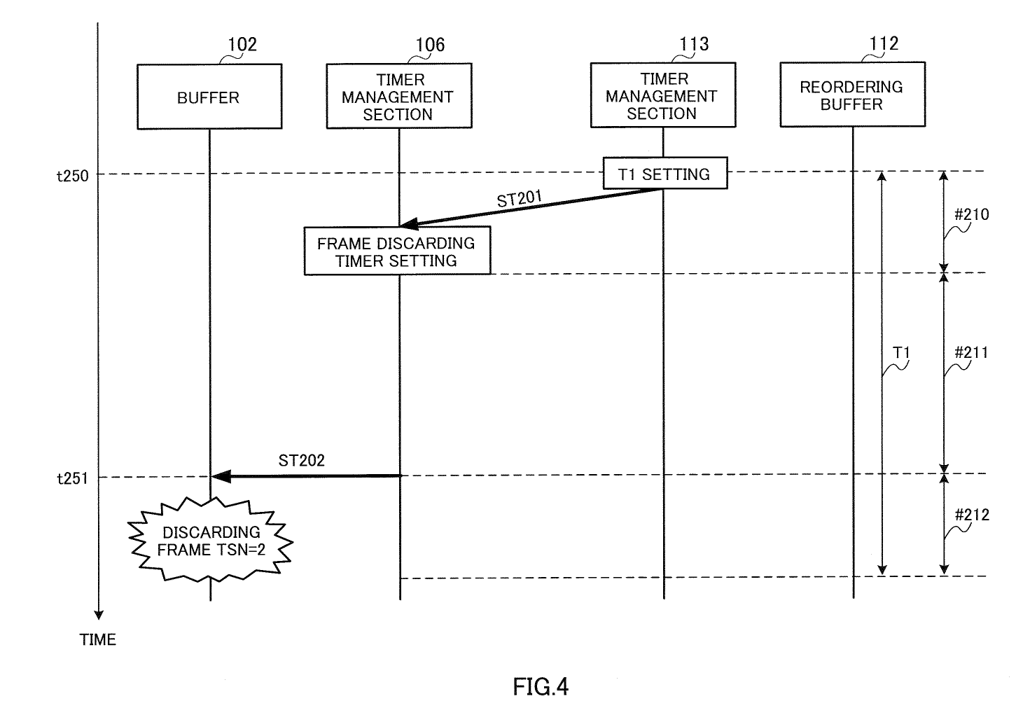

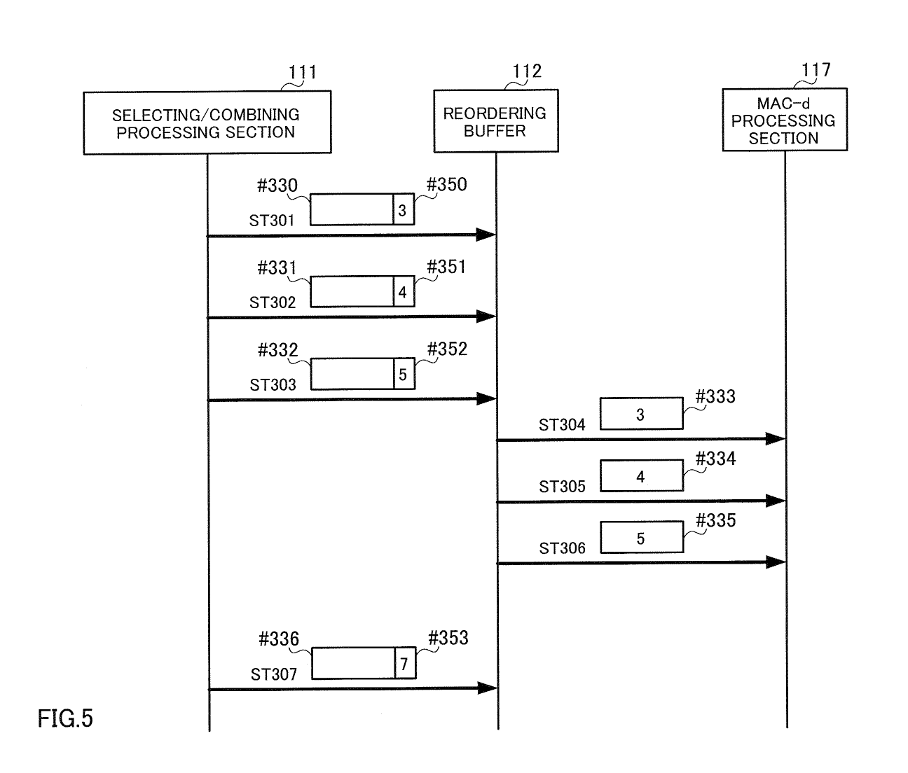

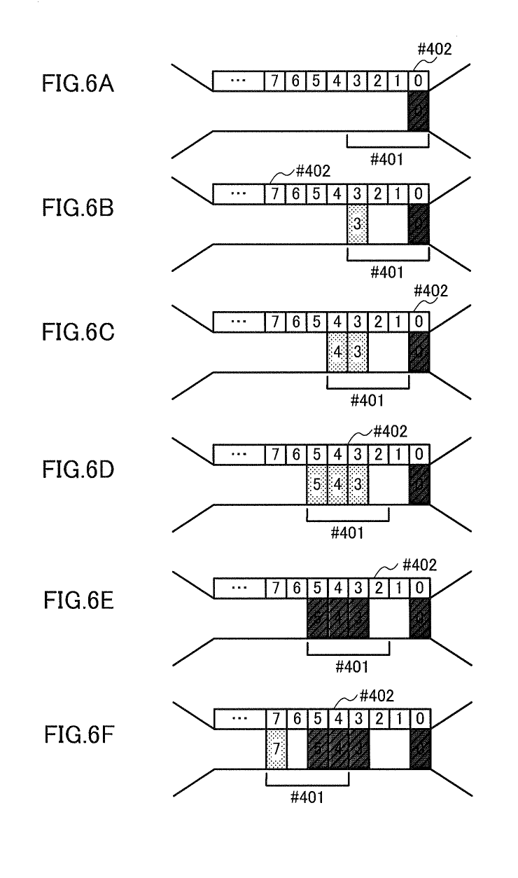

Next, the operation of Node B 121 and RNC 122 will be described using FIGS. 4 to 6. FIG. 4 is a sequence diagram that shows the operation of Node B 121 and RNC 122, FIG. 5 is a sequence diagram showing an operation of RNC 122, and FIG. 6 are views showing states of alignment buffer 112.

Timer managing section 113 of RNC 122 monitors alignment buffer 112 each time the maximum waiting time is activated and at the same time sets a set value T1 of the maximum waiting time, and transmits a control frame which includes information about the maximum waiting time, in which the set value T1 of the maximum waiting time, TSN (T1_TSN) which is the object of the setting, and the CFN at the setting time represent information elements, to timer managing section 106 of Node B 121 (step ST201). Then, timer managing section 106 of Node B 121, at which the control frame is received, activates the frame discarding timer and monitors buffer 102. Here, CFN represents the frame number which is counted by Node B 121 and RNC 122 in common. The frame discarding timers of RNC 122 and Node B 121 can thus be synchronized with each other.

Timer managing section 106 of Node B 121 sets the frame discarding timer inside buffer 102 using equation 1, based on the T1 and CFN which have been reported.

Frame discarding timer=T1−2×(transmission delay between RNC 122 and Node B 121) (Equation 1)

Also, the transmission delay #210 between RNC 122 and Node B 121 can be determined using equation 2.

Transmission delay between RNC 122 and Node B 121=(CFN of Node B 121 at the time the control frame is received)−CFN set in the control frame) (Equation 2)

On the one hand, alignment buffer 112 has a set value T1 of the maximum waiting time and the receive window size as variables. Also, alignment buffer 112 has next_expected_TSN, which shows the TSN counter value of the packet data to be next transmitted to MAC-d processing section 117, RcvWindow_UpperEdge, which shows the maximum TSN counter value of the receive window, and T1_TSN, which shows the TSN counter value which is the object of activation of the set value T1 of the maximum waiting time, as state variables. The value of the set value T1 of the maximum waiting time is set based on the maximum number of retransmissions in HARQ, transmission time interval (TTI), number of processes in HARQ, and delay of the Iub/Iur interface, etc.

In alignment buffer 112, the packet data is stored in the place of the above-mentioned TSN counter value. For instance, in FIG. 6A to FIG. 6F, assuming that the receive window size #401 is 4 and the packet data whose TSN counter value #402 is “0” (TSN=0) is stored in alignment buffer 112, and transmitted to MAC-d processing section 117, alignment buffer 112 enters the state of FIG. 6A. At this time, next_expected_TSN=1 and RcvWindow_UpperEdge=3, and the set value T1 of the maximum waiting time is not activated.

Next, when RNC 122 receives packet data whose TSN counter value is “3” (TSN=3), as shown in FIG. 5, the packet data #330 whose TSN counter value #350, which is larger than next_expected_TSN=1, is “3,” is stored from selecting and combining processing section 111 into alignment buffer 112 (step ST301), and therefore, the set value T1 of the maximum waiting time is activated and becomes T1_TSN=3, and the alignment buffer 112 enters the state of FIG. 6B.

Next, by receiving packet data #331 whose TSN counter value #351 is “4” (TSN=4) and storing it from selecting and combining processing section 111 into alignment buffer 112 (step S302), the receive window #401 is updated and becomes RcvWindow_UpperEdge=4, and the alignment buffer 112 enters the state of FIG. 6C.

Also, by receiving packet data #332 whose TSN counter value #352 is “5” (TSN=5) and storing it from selecting and combining processing section 111 to alignment buffer 112 (step ST303), receive window #401 is updated and becomes RcvWindow_UpperEdge=5, and since the TSN counter value “1” (TSN=1) is removed from the receive window #401, next_expected_TSN=2, and alignment buffer 112 enters the state of FIG. 6D. After that, when packet data whose TSN counter value is “2” (TSN=2) cannot be received, the packet data whose TSN counter value is equal to or greater than “3” cannot be transmitted to MAC-d processing section 117, and the frame discarding timer expires. Consequently, as shown in FIG. 5, packet data #333, #334 and #335 which have already been stored and whose TSN counter values are “3” to “5” (TSN=3 to 5) are transferred to MAC-d processing section 117 (step ST304, step ST305 and step ST306), next_expected_TSN becomes next_expected_TSN=6 of the packet data whose T1_TSN is equal to or greater than “3” and which could not be received by alignment buffer, and alignment buffer 112 enters the state of FIG. 6E.

When the frame discarding timer has expired, timer managing section 106 of Node B 121 commands buffer 102 to discard the uplink packet data (step ST202). Buffer 102, which received the frame discarding command, checks the TSN of the uplink packet data stored therein and discards all uplink packet data, from the uplink packet data stored therein, which have a TSN equal to or lower than the TSN which is the object of setting (T1_TSN) For instance, when Node B 121 attempts to transmit the packet data whose TSN counter value is “2” to RNC 122, since timer managing section 106 of Node B 121 receives information about the maximum waiting time in step ST 201, Node B 121 recognizes that the set value T1 of the maximum waiting time has expired and commands buffer 102 to discard the packet data whose TSN counter value is “2”. As a result, the packet data whose TSN counter value is “2” is not transmitted from Node B 121 to RNC 122. Here, the timing at which Node B 121 reports the discard of packet data to buffer 102 is time t251, which has passed from time t250, at which the set value of the maximum waiting time is set, for the time obtained by deducing the transmission delay #212 between RNC 122 and Node B 121 at the time the packet data is transmitted from Node B121 to RNC 122, from the set value T1 of the maximum waiting time. Time #211 from the tine the frame discarding timer is set in timer managing section 106 until the time the frame discard is reported to buffer 102, represents the time which is obtained by deducing transmission delay #211 between RNC 122 and Node B 121 and transmission delay #212 between RNC 122 and Node B 121, from the set value T1 of the maximum waiting time. Next, RNC 122 receives packet data #336 whose TSN counter value #353 is “7” (TSN=7), and by storing it from the selecting and combining processing section 111 into alignment buffer 112 (step ST307), the receive window #401 is updated and becomes RcvWindow_UpperEdge=7. Also, since the TSN counter value #353 is larger than next_expected_TSN=6, T1 is activated and becomes T1_TSN=7, and alignment buffer 112 enters the state of FIG. 6F. By means of the above-described processing, alignment buffer 112 carries out order correction of packet data.

Thus, according to the embodiment of the present invention, packet data that is to be discarded in the control station apparatus is discarded in the base station apparatus, instead of being transmitted to the control station apparatus, so that the traffic amount can be suppressed.

In the above-described embodiment, the maximum waiting time is reported using CFN. However, it is by no means limiting, and the maximum waiting time may be reported by other methods besides CFN.

The present application is based on Japanese Patent Application No. 2004-312077, filed on Oct. 27, 2004, the entire content of which is expressly incorporated by reference herein.

### INDUSTRIAL APPLICABILITY

The control station apparatus, the base station apparatus and the packet data discarding method according to this invention are suitable for application to, for example, a W-CDMA high-speed packet transmission scheme.

1. A control station apparatus comprising:
a receiving section that receives packet data transmitted from a base station apparatus;
a first accumulating section that accumulates the packet data received by the receiving section on a temporary basis and arranges the accumulated packet data in a right order;
a protocol processing section that carries out predetermined protocol processing on the packet data arranged in the right order at the first accumulating section;
a timer managing section that sets a maximum waiting time, which is a predetermined time from when the packet data is accumulated in the first accumulating section until the packet data is discarded without being subjected to the protocol processing at the protocol processing section; and
a reporting section that reports information about the maximum waiting time set by the timer managing section, to the base station apparatus.

2. The control station apparatus of claim 1, wherein the timer managing section sets the maximum waiting time on a timer synchronized with the base station apparatus.

3. A base station apparatus that communicates with the control station apparatus of claim 1, the base station apparatus comprising:
a radio receiving section that receives packet data transmitted from a communication terminal apparatus;
a second accumulating section that accumulates the packet data received by the radio receiving section on a temporary basis;
a transmitting section that transmits the packet data accumulated in the second accumulating section to the control station apparatus at a predetermined timing;
a discarding section that discards, from the packet data accumulated in the second accumulating section, packet data that is going to be discarded if transmitted to the control station apparatus, instead of transmitting said packet data from the transmitting section, based on information about the maximum waiting time reported to the reporting section.

4. A packet data discarding method comprising the steps of:
transmitting packet data from a communication terminal apparatus to a base station apparatus;
accumulating the packet data received by the base station apparatus, in the base station apparatus, on a temporary basis;
transmitting the packet data accumulated in the base station apparatus to a control station apparatus at a predetermined timing;
accumulating the packet data received by the control station apparatus in the control station apparatus on a temporary basis and arranging the accumulated packet data in a right order;
carrying out predetermined protocol processing on the packet data arranged in the right order;
setting a maximum waiting time, which is a predetermined time from when the packet data is accumulated until said packet data is discarded without being subjected to the protocol processing;
transmitting information about the set maximum waiting time from the control station apparatus to the base station apparatus;
receiving at the base station apparatus information about the maximum waiting time from the control station apparatus; and
at the base station apparatus, discarding, from the packet data accumulated in the base station apparatus, packet data that is going to be discarded if transmitted to the control station apparatus, instead of transmitting said packet data to the control station apparatus, based on the information about the maximum waiting time received at the base station apparatus.
